(19) United States
(12) Patent Application Publication
(10) Pub. No.: US 2016/0037958 A1
(43) Pub. Date: Feb. 11, 2016

(54) COOKING APPARATUS WITH ROBOTIC ARM

(71) Applicant: CARRIER COMMERICAL REFRIGERATION, INC., Farmington, CT (US)

(72) Inventors: Otley D. Freymiller, Deerfield, WI (US); Jeffrey L. Sands, Freeport, IL (US); Dennis J. Nelson, Rockford, IL (US); Ronald J. Glavan, Rockton, IL (US)

(21) Appl. No.: 14/776,261

(22) PCT Filed: Mar. 10, 2014
(86) PCT No.: PCT/US14/22560

§ 371 Date: Sep. 14, 2015

Related U.S. Application Data
(60) Provisional application No. 61/794,587, filed on Mar. 15, 2013.

(51) Int. Cl. A47J 27/62; A47J 37/06

(52) U.S. Cl. CPC A47J 27/62; A47J 37/0611; A47J 2037/0617

(57) ABSTRACT

A cooking apparatus includes a base including a lower heating plate and an upper heating unit including an upper heating plate. The cooking apparatus includes a robotic arm connected to the upper heating unit to move the upper heating plate between at least a cooking position adjacent to the lower heating plate and a non-cooking position separated from the lower heating plate based on a control program.

### BACKGROUND OF THE INVENTION

Embodiments of the invention relate to a cooking apparatus, and in particular to a cooking apparatus having an upper heating plate that is controlled by a robotic arm.

Grills for cooking apply heat from a lower heating plate and from an upper heating plate to opposite sides of a food item to decrease cook times and to cook food evenly. However, in conventional systems, an operator must monitor cook-times and a gap between heating plates, and operator error or cooking product variation may result in uneven cooking quality. In addition, cleaning of the upper heating plate requires reaching across the lower heating plate.

### BRIEF DESCRIPTION OF THE INVENTION

Embodiments of the present invention include a cooking apparatus including a base and an upper heating unit. The base includes a lower heating plate and the upper heating unit includes an upper heating plate. The cooking apparatus includes a robotic arm connected to the upper heating unit to move the upper heating plate between at least a cooking position adjacent to the lower heating plate and a non-cooking position separated from the lower heating plate based on a control program.

Embodiments of the invention further include a method of controlling a cooking apparatus including measuring a characteristic of one of a base of the cooking apparatus and an upper heating unit of the cooking apparatus. The base includes a lower heating plate and the upper heating unit includes an upper heating plate. The cooking apparatus includes a robotic arm connected to the upper heating unit. The method further includes controlling the robotic arm with a control program to move the upper heating unit between a cooking position having the upper heating plate adjacent to the lower heating plate and a non-cooking position having the upper heating plate separated from the lower heating plate.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 illustrates a cooking apparatus according to one embodiment of the invention;

FIG. 2 illustrates a cooking apparatus according to another embodiment of the invention;

FIG. 3 illustrates a cooking apparatus according to another embodiment of the invention; and

FIG. 4 is a flowchart of a method according to an embodiment of the invention.

### DETAILED DESCRIPTION OF THE INVENTION

Conventional grilling apparatuses require an operator to raise and lower an upper heating unit for cooking and cleaning. In addition, conventional grilling apparatuses may cook product unevenly when the product is uneven on a lower heating plate. Embodiments of the invention relate to a cooking apparatus having upper and lower heating plates, and a robotic arm connected to the upper heating plate to move the upper heating plate towards and away from the lower heating plate.

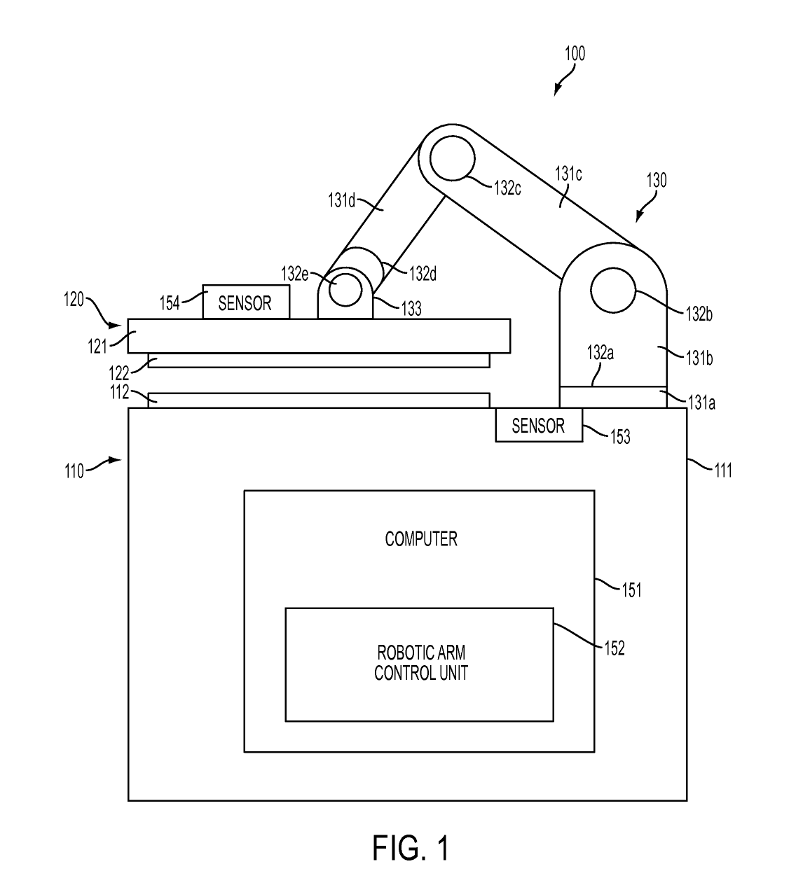

FIG. 1 illustrates a cooking apparatus 100 according to an embodiment of the invention. In one embodiment, the cooking apparatus 100 is a grilling apparatus for grilling food. The cooking apparatus 100 includes a base 110 including a housing 111 that rests on the ground, floor or another surface. The base 110 also includes a first heating plate 112, which may be referred to as a lower heating plate 112. The cooking apparatus 100 also includes an upper heating unit 120 including a housing 121 and an upper heating plate 122.

In FIG. 1, one configuration of a cooking apparatus 100 is illustrated including a single heating plate 112 on a housing 111 and a single upper heating unit 120. However, embodiments of the invention encompass any configuration of base 110, lower heating plate 112, upper heating unit 120 and upper heating plate 122, including multiple lower or upper heating plates or multiple upper heating units 120.

The cooking apparatus 100 includes a robotic arm 130 connected to the upper heating unit 120 to control the upper heating unit 120. The robotic arm 130 moves the upper heating unit 120 between at least one cooking position and at least one non-cooking position. The at least one cooking position includes any number of positions having the upper heating plate 122 next to the lower heating plate 112, separated by any number of predetermined gaps. The gaps may be fixed gaps determined based on a computer program, or based on a sensed type of food located on the lower heating plate 112. For example, the robotic arm 130 may control the upper heating plate 122 to have a gap of a first distance corresponding to a first type of food or a second distance corresponding to a second type of food. Alternatively, the robotic arm 130 may control the upper heating plate 122 to have a gap that varies from one part of the upper heating plate 122 to another part of the upper heating plate 122 based on foods of different heights positioned on the lower heating plate 112.

The at least one non-cooking position may include, for example, a stand-by position at which food is placed on the lower heating plate 112, a shut-down position and a cleaning position. By way of example, the stand-by position may consist of the upper heating plate 122 positioned over the lower heating plate 112 at an angle with respect to the lower heating plate 112. The cleaning position may include rotating the robotic arm 130 around a vertical axis or other axis perpendicular to a plane defined by the lower heating plate 112 to be un-aligned with the lower heating plate 112. In other words, during normal operation, the upper heating plate 122 rotates around a horizontal axis, defined by at least one joint of the robotic arm 130, to move up from, and down towards, the lower heating plate 112. However, during a cleaning or non-cooking operation, the robotic arm 130 may be rotated around an axis perpendicular to the plane defined by the lower heating plate 112 so that if the robotic arm 130 rotates around a horizontal axis, or other axis parallel to the plane defined by the lower heating plate 112, the upper heating plate 122 is not aligned with the lower heating plate 112. Such a position may allow a user to access the upper heating plate for cleaning, repair or inspection without reaching over the lower heating plate 112.

The robotic arm 130 may include at least three axes of rotation. For example, the robotic arm 130 in FIG. 1 includes five axes of rotation, defined by joints 132a, 132b, 132c, 132d and 132e. The joint 132a defines a vertical axis of rotation, or an axis of rotation perpendicular to a plane defined by the lower heating plate 112. The joints 132b, 132c and 132e define horizontal axes of rotation, or axes of rotation that are parallel to the ground or to the lower heating plate 112. The robotic arm 130 includes arm segment 131a, which is mounted to the housing 111, and arm segments 131b, 131c and 131d. The arm segment 131d is connected to a mounting segment 133 via the joint 132e. In one embodiment, the mounting segment 133 is permanently attached to the housing 121, and in an alternative embodiment, the mounting segment 133 is removably attached, such as by clamps, latches, brackets, screws, male-female connectors or any other detachable mounting devices or structures. In yet another embodiment, the mounting segment 133 may include a grasping mechanism that is actuated to grasp a mounting structure of the housing 121.

The joint 132d is located along the arm segment 131d and defines a rotation axis parallel to an approximate center length axis of the arm segment 131d. While one example of a robotic arm 130 is illustrated in FIG. 1, embodiments of the invention encompass any robotic arm including any number of arm segments and joints, providing any range of motion. In embodiments of the invention, the robotic arm 130 may have a number and type of joints and arms such that the upper heating unit 120 may have any inclination, including horizontal, vertical, below horizontal, acute and obtuse. In one embodiment, the robotic arm 130 includes at least one joint 132 located on an opposite side of the upper heating plate 122 from the lower heating plate 121. The joint 132 may define a rotation axis parallel to the lower heating plate 112, such that rotating the joint 132 results in the robotic arm 130 exerting force on the upper heating plate 122 from above the upper heating plate 122.

In one embodiment, the robotic arm 130 has sufficient axes of rotation to permit the robotic arm 130 to flip the upper heating plate 122 from facing downward, as illustrated in FIG. 1, to facing upward. For example, the upper heating plate 122 may be used to cook an upper side of a food product resting on the lower heating plate 112, then the upper heating plate may be flipped to face upwards, and may be used to cook the underside of another food product, such as to toast a bun.

The cooking apparatus 100 further includes a computer 151 including a robotic arm control unit 152 for controlling the robotic arm 130. The computer 151 includes a processing circuit, programmable logic, memory and any other circuitry for receiving, analyzing processing and transmitting data. The cooking apparatus 100 also includes sensors 153 and 154. In one embodiment, the sensors 153 and 154 detect an attitude of the upper heating unit 120 or the upper heating plate 122 and transmit a signal with data regarding the position of the upper heating unit 120 or the upper heating plate 122 to the computer 151. In addition, the sensor 153 may detect the attitude of the base 110 or the lower heating plate 112 and may transmit a corresponding signal to the computer 151. The computer 151 controls the robotic arm 130 based on the signals from the sensors 153 and 154.

Embodiments of the invention encompass any type of sensor capable of providing position data or other cooking data to the computer 151. Examples of sensors include inclinometers, accelerometers, pressure sensors, temperature sensors and optical sensors. While FIG. 1 illustrates two sensors 153 and 154 located in the base 110 and the upper heating unit 120, embodiments encompass sensors located at any position in the upper heating unit 120 and base 110. In addition, while two sensors are illustrated for purposes of description, embodiments of the invention encompass one sensor in one or the other of the upper heating unit 120 and the base 110 or three or more sensors.

In one embodiment, one or both of the sensors 153 and 154 is a sensor configured to recognize a type of food placed on the lower heating plate 112. In such an embodiment, the computer 151 recognizes the type or class of food placed on the lower heating plate 112 and the robotic arm control unit 152 controls the robotic arm 130 based on the detected type of food to set a gap between the lower heating plate 112 and the upper heating plate 122, to exert a force of a predetermined degree on the upper heating plate 122, such that a predetermined pressure is exerted upon food located on the lower heating plate 112.

In one embodiment, a food product is placed on the lower heating plate 112. One of the sensors 153 and 154 may detect the type of food product based on size, weight, image recognition or any other recognition process. Alternatively, a user may enter a control program selection indicating a type of food product that is placed on the lower heating plate 112. The robotic arm control unit 152 controls the robotic arm 130 to position the upper heating unit 120 above the lower heating plate 112, such that a predetermined gap exists between the upper heating plate 122 and the lower heating plate 112 according to the type of food. The gap may be a constant gap over the entire area of the upper and lower heating plates 112 and 122 or the gap may vary according to different detected heights of the food product detected on the lower heating plate 112. In addition, the gap may vary over the course of cooking the food product. For example, the gap may be wider at the beginning of a cooking process and the robotic arm control unit 152 may control the robotic arm 130 to incrementally decrease a size of the gap over time.

In one embodiment, the gap is measured by one or both of the sensors 153 and 154. In another embodiment, the gap is determined by detecting the state of the robotic arm 130. For example, the robotic arm may be calibrated to have a known reference position, such as a rest position or a position in which the upper heating plate 122 contacts the lower heating plate 112. The gap may then be measured by determining the state of the joints 132a-132e of the robotic arm relative to the reference position.

The cooking process may be completed by sensing that the food product is cooked or based on an elapsed cook time. The robotic arm control unit 152 may then control the robotic arm 130 to lift the upper heating unit 120 away from the lower heating plate 112. If another food product is going to be cooked, the upper heating unit 120 may be lifted to an angle away from the lower heating plate 112 that is safe for an operator to apply food, such as between seventy-five and ninety degrees. If the upper or lower heating plates 122 or 112 needs to be cleaned, the upper heating unit 120 may be rotated around a vertical axis to be un-aligned with the lower heating plate 112, allowing an operator to access the upper heating plate 122 without reaching across the lower heating plate 112. According to an alternative cleaning process, the robotic arm 130 may rotate and actuate the joints 132b, 132c and 132e to rub or slide the upper heating plate 122 along a stationary cleaning structure, such as a stationary squeegee or stiff cleaning structure. The stationary cleaning structure may scrape or squeegee food by-products off of the upper heating plate 122.

The above gaps, positions and operations of the cooking apparatus 100 are provided only by way of example. Embodiments of the invention encompass controlling to robotic arm 130 to move the upper heating unit 120 into any angle relative to the lower heating plate 112, or to have any gap relative to the lower heating plate 112.

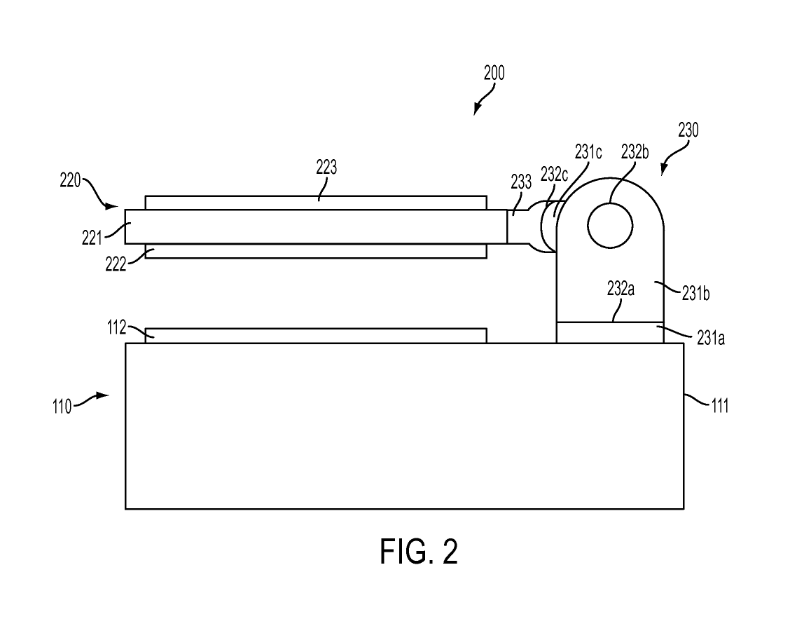

FIG. 2 illustrates a cooking apparatus 200 according to another embodiment of the invention. The cooking apparatus 200 includes the base 110, housing 111 and lower heating plate 112 and the upper heating unit 220, housing 221 and upper heating plate 222. The cooking apparatus 200 includes a robotic arm 230 including arm segments 231a, 231b and 231c and joints 232a, 232b and 232c. The robotic arm 230 further includes a mounting portion 233 connected to an end of the housing 221. The mounting portion 233 may include clamps, latches, brackets, screws, male-female connectors or any other detachable mounting devices or structures. In addition, the mounting portion 233 may be a grasping mechanism that is actuated to grasp and release a grasping mount of the upper heating unit 220. As discussed with reference to the robotic arm 130 of FIG. 1, the robotic arm 230 may control the upper heating unit 220 to have any inclination angle, including horizontal, vertical, acute and obtuse to place the upper heating unit 220 in one or more cooking positions and one or more non-cooking positions.

In addition, the cooking apparatus 200 includes a second upper heating plate 223 located on an opposite side of the housing 221 from the upper heating plate 222. During operation, the upper heating unit 220 may be arranged such that the upper heating plate 222 faces the lower heating plate 112 to cook one type of food product, and the robotic arm 230 may raise the upper heating unit 220 and rotate the upper heating unit 220 such that the second upper heating plate 223 faces the lower heating plate 112 to cook the same or another food product. In one embodiment, the upper heating plate 222 has a different surface structure than the second upper heating plate 223. For example, in one embodiment, the upper heating plate 222 is a grilling surface including ridges and the second upper heating plate 223 is flat surface.

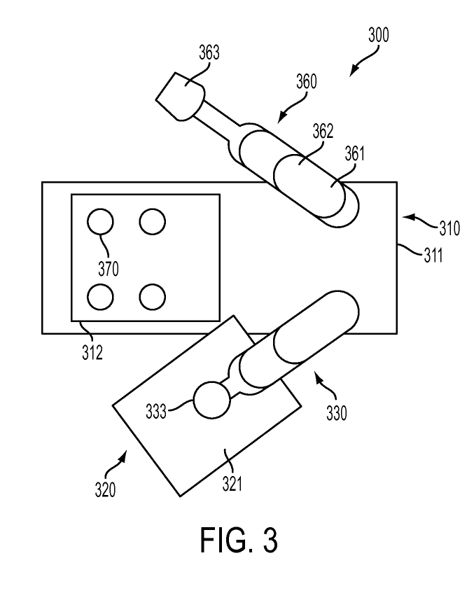

FIG. 3 illustrates a cooking apparatus 300 according to another embodiment of the invention. The cooking apparatus 300 includes a base 311 including a housing 311 and a lower heating plate 312 for receiving a food product 370 thereon. The cooking apparatus 300 includes a robotic arm 330, which may correspond to the robotic arm 130 of FIG. 1 or the robotic arm 230 of FIG. 2. The robotic arm 330 is connected to an upper heating unit 320, which may correspond to the upper heating unit 120 of FIG. 1, via a connection portion 333. The upper heating unit 320 includes a housing 321 and an upper heating plate (not shown in FIG. 3), such as the upper heating plate 122 of FIG. 1.

The cooking apparatus 300 also includes a food preparation robotic arm 360 including arm segments 361 and joints 362 to provide the food preparation arm 360 with a range of motion. The food preparation robotic arm 360 includes a food manipulation attachment 363 for preparing food. In embodiments of the invention, the food manipulation attachment 363 may move food 370 from a storage area to the lower heating plate 312, may provide seasoning to the food 370, or otherwise treat, shape or prepare the food 370 and remove the food 370 from the lower heating plate 312.

In one example embodiment, a user or system enters a command or control program to cook a certain type of food by the cooking apparatus 300. The food preparation arm 360 retrieves the food indicated by the control program from a storage area. Alternatively, a user may place food on the lower heating plate 312. The control program may control a temperature of the upper heating plate and lower heating plate 312. The control program controls the robotic arm 330 to position the upper heating unit 320 over the base 311, such that an upper heating plate is positioned over the lower heating plate 312 separated by a predetermined gap according to a type of food being cooked.

The control program, or a controller (not shown in FIG. 3) running the control program, controls one or more of the temperature, pressure, alignment and inclination of the upper heating plate and the lower heating plate 312 based on the type of food being cooked. After a predetermined time indicated by the control program has elapsed, the controller controls the robotic arm 330 to move the upper heating unit 320 away from the base 310, and the food preparation arm 360 removes the food 370 from the lower heating plate 312.

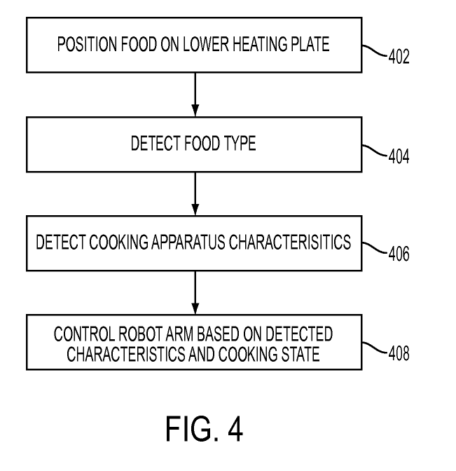

FIG. 4 illustrates a method according to an embodiment of the invention. In block 402, food is positioned on a lower heating plate of a cooking apparatus. The food may be positioned by a robotic arm or by a user.

In block 404, a type, shape or other dimension of the food is detected. The food type may be detected by one or more sensors of a cooking apparatus, including optical sensors, weight sensors, image recognition circuitry or any other sensor or circuitry.

In block 406, characteristics of the cooking apparatus are detected, such as a gap between an upper heating unit and a base, a gap between an upper heating plate and a lower heating plate, a pressure of an upper heating plate on food or on the lower heating plate, a temperature of the food or any other characteristic. The characteristics may be measured by one or more sensors of the cooking apparatus, including pressure sensors, temperature sensors, optical sensors, accelerometers, inclinometers or any other type of sensor.

In block 408, a robotic arm is controlled based on the detected characteristic and a cooking state. For example, if a first type of food is detected, the robotic arm may move the upper heating unit to maintain a gap of a first size between an upper heating plate and a lower heating plate. Alternatively, the robotic arm may be programmed to maintain a gap of a predetermined size between the lower heating plate and the upper heating plate regardless of a type of food. In addition, the robotic arm is controlled based on a cooking state, such as to be placed in a cooking position or a non-cooking position. If it is determined that the cooking apparatus is in a stand-by, power down or cleaning state, the robotic arm may be controlled to move the upper heating plate to be apart from the lower heating plate and accessible by a user. On the other hand, if it is determined that the cooking apparatus is in a cooking state, the upper heating plate may be brought into the vicinity of the lower heating plate to cook two sides of a food product with a lower heating plate and with an upper heating plate having a position determined by the robotic arm.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A cooking apparatus, comprising:
a base including a lower heating plate;
an upper heating unit including an upper heating plate; and
a robotic arm connected to the upper heating unit to move the upper heating plate between at least a cooking position adjacent to the lower heating plate and a non-cooking position separated from the lower heating plate based on a control program.

2. The cooking apparatus of claim 1, wherein the robotic arm is mechanically connected to the base.

3. The cooking apparatus of claim 1, further comprising:
a control computer having stored therein the control program.

4. The cooking apparatus of claim 3, further comprising:
at least one sensor to detect a characteristic of at least one of the upper heating unit and the base,
wherein the control computer is configured to control the robotic arm based on an output signal of the at least one sensor.

5. The cooking apparatus of claim 4, wherein the at least one sensor is configured to measure at least one of a force provided by the upper heating plate, a distance between the upper heating unit and the base and a temperature of at least one of the upper heating plate and the lower heating plate.

6. The cooking apparatus of claim 1, wherein the robotic arm has at least three axes of rotation.

7. The cooking apparatus of claim 6, wherein the robotic arm is configured to apply pressure to an upper surface of the upper heating unit by rotating at least one of the three axes of rotation.

8. The cooking apparatus of claim 1, wherein the robotic arm is attached to an upper surface of the upper heating unit.

9. The cooking apparatus of claim 8, wherein the robotic arm includes a joint located on an opposite side of the upper heating unit from the base when the upper heating unit is in the cooking position, such that actuating the joint causes the robotic arm to exert a force on the upper heating plate in a direction of the base.

10. The cooking apparatus of claim 1, further comprising:
at least one food preparation robotic arm configured to perform at least one of preparing food to be placed on the lower heating plate, prepare food located on the lower heating plate, remove food from the lower heating plate and clean one of the upper heating plate and the lower heating plate.

11. The cooking apparatus of claim 10, wherein each of the robotic arm and the food preparation robotic arm are mounted on the base.

12. The cooking apparatus of claim 1, wherein the robotic arm is connected to an end of the upper heating unit; and
the robotic arm includes a joint configured to rotate the upper heating unit such that a first surface of the upper heating unit faces the lower heating plate and a second surface of the upper heating unit faces the lower heating plate, the second surface of the upper heating unit located opposite the first surface of the upper heating unit.

13. The cooking apparatus of claim 12, wherein the upper heating plate is located on the first surface of the upper heating unit and a second upper heating plate is located on the second surface of the upper heating unit.

14. The cooking apparatus of claim 1, wherein the robotic arm has sufficient axes of rotation to flip the upper heating plate from facing downward toward the lower heating plate to facing upward away from the lower heating plate.

15. A method of controlling a cooking apparatus, comprising:
measuring a characteristic of one of a base of the cooking apparatus and an upper heating unit of the cooking apparatus, the base including lower heating plate and the upper heating unit including an upper heating plate, the cooking apparatus including a robotic arm connected to the upper heating unit; and
controlling the robotic arm with a control program to move the upper heating unit between a cooking position having the upper heating plate adjacent to the lower heating plate and a non-cooking position having the upper heating plate separated from the lower heating plate.

16. The method of claim 15, wherein controlling the robotic arm includes actuating at least one joint in the robotic arm to move the upper heating plate towards the lower heating plate.

17. The method of claim 15, wherein measuring the characteristic includes measuring a pressure of the upper heating plate against a food product on the lower heating plate, and
controlling the robotic arm includes actuating the at least one joint to increase a pressure of the upper heating plate against the food product on the lower heating plate.

18. The method of claim 15, wherein controlling the robotic arm to move the upper heating unit into the non-cooking position includes rotating the robotic arm around an axis perpendicular to a plane defined by the lower heating plate such that the upper heating plate is un-aligned with the lower heating plate.

19. The method of claim 15, further comprising:
analyzing, by a food product detection sensor, a food product on the lower heating plate,
wherein controlling the robotic arm includes controlling at least one of a gap between the upper heating plate and the lower heating plate, an alignment of the upper heating plate relative to the lower heating plate and a force applied by the upper heating plate on the food product.
